(19) United States
(12) Patent Application Publication
(10) Pub. No.: US 2006/0111807 A1
(43) Pub. Date: May 25, 2006

(54) Device, system and method for calibration in three-dimensional model printing

(76) Inventors: Hanan Gothait, Rehovot (IL); Meir Bar Nathan, Rishon LeZion (IL)

Correspondence Address: PEARL COHEN ZEDEK, LLP, 1500 BROADWAY 12TH FLOOR, NEW YORK, NY, 10036, US

(21) Appl. No.: 10/527,907

(22) PCT Filed: Sep. 11, 2003
(86) PCT No.: PCT/IL03/00746

§ 371 Date: Oct. 20, 2005

Related U.S. Application Data
(60) Provisional application No. 60/409,996, filed on Sep. 12, 2002.

(51) Int. Cl. G06F 19/00

(52) U.S. Cl. 700/119

(57) ABSTRACT

Devices, systems and methods for three-dimensional model printing. A three-dimensional model printer may, for example, calibrate, optimize, or indicate the need for replacement of or evaluation of one or more printing heads or nozzles of the three-dimensional model printer.

### FIELD OF THE INVENTION

The present invention relates to devices, systems and methods for calibration of three-dimensional model printing apparatus and the detection of malfunctioning printing heads and/or nozzles in the apparatus

### BACKGROUND OF THE INVENTION

Three-Dimensional (3-D) printing is a process used for the production of 3-D models by building parts, typically in layers. Such 3-D models are used, for example, as 3-D prototypes for industry and/or production of parts and/or tools for use in a manufacturing process.

Various systems have been developed for computerized 3-D printing, otherwise known as Rapid Prototyping (RP) or Rapid Prototyping and Manufacturing (RP&M). Typically, objects are built up in consecutive layers according to a pre-determined configuration or in selected arrays as defined by, for example, a Computer Aided Design (CAD) system connected to suitable 3-D printing machinery. The interface materials employed in the object-building process may be selected from amongst a number of suitable materials, such as, for example, photopolymers, waxes, powders, plastics and/or metals, which may be used for the building of the 3-D model or as support materials.

For example, in one system for building a 3-D model in layers, a layer of powdered material is deposited, and this is followed by a deposit of binding material in selected parts of the powder deposit to form a layer of bound powder in these parts. These operations may be repeated for successive layers to form a desired component.

In another system, the printing technique is typically based on selective layer-upon-layer deposition of one or more materials (other numbers may be used) via ink-jet heads, the materials typically comprising different combinations of building material (BM) and/or support material (SM).

The BM may be, for example, a specially formulated photopolymer, cured for example by a source of electromagnetic irradiation, for example a flood or wide area of light, which is usually Ultra-Violet (UV) light, but other wavelengths and curing techniques may be used. The SM may also be a photopolymer.

The systems of the above-mentioned patents and patent applications may include an apparatus with one or more inkjet printing heads, forming part of a printing block. Each printing head may have an array of one or more nozzles. From each of the printing heads and/or nozzles, one or more types of photopolymer materials may be dispensed separately or together, simultaneously or consecutively, or in any suitable combination onto a printing surface below the printing head or printing heads.

While the drop volume of drops of interface material should preferably be consistent, this does not necessarily occur in actual 3-D printing and object building. For example, throughout a model building process (which may typically include deposit of photopolymer materials, curing of the deposited material and leveling), purging and wiping of the inkjet printing heads may be periodically performed. These processes may lead to an accumulation of excess cured material on the printing head itself, in and/or around one or more nozzles, between printing heads and/or other parts of the printing apparatus.

Such accumulation of cured material, in conjunction with ambient UV radiation, may cause various problems, for example, blockage of one or more nozzles in the printing head. A major result of such problems is that one or more printing heads may become ineffective or damaged, entirely or to a certain extent, and there may be a need to replace such defective printing heads.

Additionally or alternatively, one or more nozzles on a printing head may be partially or completely blocked. If one or more of the nozzles in the array is blocked or is partially blocked or impaired, the affected nozzle or nozzles may not deposit the required amount of interface material, and in some cases may not deposit any material at all. This may result in a repeated lack of interface material deposit at a specific point or points or in specific locations, resulting in imperfections in the 3-D model at the position of, or along the axis of movement of, the problematic nozzle or nozzles.

Additionally, for example, the inkjet printing head or heads, whose operation may be based on piezoelectric elements that contract or expand in reaction to the application of an electrical voltage/drive pulse to their electrodes, may show a degradation in efficiency with time, for example, due to a weakening of the piezo elements. Such degradation may cause, for example, a decrease in drop volume or drop weight, and/or non-uniformity in drop volume or drop weight.

There is a need for advanced apparatus, system and methods for locating problems such as blocked nozzles and/or imperfections in the printing heads and for providing adequate solutions for such problems.

### SUMMARY OF THE INVENTION

Various embodiments of the present invention provide, for example, devices, systems and methods for evaluating and/or locating one or more dispensing units such as blocked or dysfunctional nozzles and/or printing heads and possibly for compensating their lack and/or dysfunction.

Various embodiments of the invention provide, for example, devices, systems and methods for calibration of drop volume in 3-D selective deposition model printing apparatus.

Some embodiments of the invention provide, for example, devices, systems and methods for calibration, optimization, evaluation and/or replacement of one or more printing heads of a 3-D printer.

Some embodiments of the invention provide, for example, devices, systems and methods for calibration, optimization, evaluation and/or replacement of one or more nozzles of a printing head of a 3-D printer. In some alternate embodiments of the invention, measures may be taken to compensate for blocked and/or dysfunctional nozzles.

A method in accordance with one embodiment of the present invention includes, for example, modifying a property of a nozzle of a printing head of a three-dimensional model printer in relation to a property of a portion of material produced by said nozzle. In one embodiment, the method may include, for example, evaluating a nozzle or a printing head of a three-dimensional model printer in relation to a property of a portion of material (e.g., a test printing block, a measuring block, an amount of material printed, etc.) produced by said nozzle or printing head, respectively.

Some embodiments of the invention provide, for example, devices, systems and methods for calibration and/or optimization of one or more nozzles and/or printing heads of a 3-D printer. In one embodiment, for example, a drop-volume of deposited interface material may be weighed and analyzed to allow such calibration and/or optimization.

In some embodiments, one or more sensors and/or imagers may be used to measure one or more properties (e.g., a height, a distance, or a thickness) of a measuring block deposited by a 3-D printer. In one embodiment, these properties may be analyzed, for example, to allow calibration and/or optimization of a 3-D printer.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a block diagram of a 3-D printer according to an embodiment of the present invention;

FIG. 2 is a flow chart diagram of a method of calibration of a 3-D printer according to an embodiment of the present invention;

FIG. 3 is a flow chart diagram of a method of optimization according to an embodiment of the present invention;

FIG. 4 is a schematic illustration of an exemplary test pattern according to an embodiment of the present invention;

FIG. 5 is a schematic illustration of a calibration system according to an embodiment of the present invention; and

FIG. 6 is a schematic illustration of a reservoir according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Embodiments described in U.S. Pat. Nos. 6,259,962 and 6,569,373, as well as U.S. patent applications Ser. Nos. 09/412,618, 10/424,732, 10/101,089, 09/484,272 and 10/336,032, all assigned to the common assignee of the present invention and fully incorporated herein by reference, relate to apparatuses and methods for 3-D model printing. One embodiment may include, for example, a printing head having a plurality of nozzles through which interface materials are dispensed, and a dispenser connected to the printing head for selectively dispensing interface material in layers onto a printing tray. Electromagnetic radiation, for example, may be used for curing. The location of depositing and the amount and/or type of interface material to be deposited may be controlled by a controller, using, for example, CAD data. Various embodiments of the present invention may be used in conjunction with the various embodiments described in the aforementioned Patents and Patent Applications assigned to the common assignee of the present invention and fully incorporated herein by reference; however, the present invention is not limited in this respect, and embodiments of the present invention may be used in conjunction with 3-D printers having various other configurations and various other methods of operation.

It should be understood that the terms “nozzles” and/or “ink-jet nozzles” are used herein for convenience and may include nozzles similar to ink-jet nozzles, known in the art; these terms are not restricted to nozzles for ejecting ink, and they may also includes nozzles for ejecting interface material, model material and/or support material for the building of 3-D models. Additionally, the term “nozzles” may include a nozzle, a plurality of nozzles, a group or set of nozzles, and/or a plurality of groups or sets of nozzles. The “nozzles” and/or “ink-jet nozzles” described herein may in some cases not be suitable for typical ink-jet printing.

It is noted that the term “interface material” as used herein may include modeling material, support material, and/or any suitable combination of modeling material and/or support material. Furthermore, the term “interface material” as used herein may include one or more interface materials.

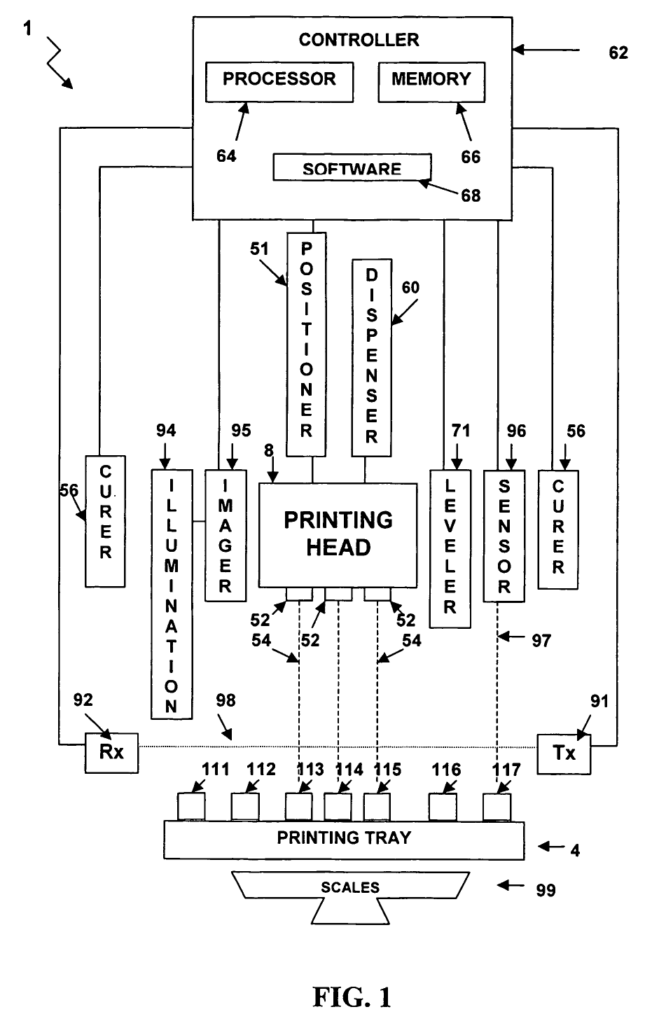

FIG. 1 is a block diagram of a 3-D printer 1 according to an embodiment of the present invention. In one embodiment, 3-D printer 1 may include, for example, a printing head 8, a material dispenser 60, a positioner 51, a controller 62, a curer 56, a leveler 71 (e.g., a roller), and a printing tray 4. 3-D printer 1 may be structured and may operate similarly to embodiments described in the aforementioned Patents and Patent Applications assigned to the common assignee of the present invention and fully incorporated herein by reference; however, 3-D printer 1 may be structured and may operate similarly to 3-D printers having other configurations and/or other methods of operation. For example, 3-D printer 1 may include more than one printing head, more than one material dispenser, and so on.

In some embodiments, 3-D printer 1 may optionally include a height/distance sensor 96. In alternate embodiments, 3-D printer 1 may optionally include a transmitter 91 and a receiver 92. In other alternate embodiments, 3-D printer 1 may optionally include height/distance sensor 96 as well as transmitter 91 and receiver 92.

In some embodiments, printing head 8 may include a plurality of nozzles 52. Nozzles 52 may be arranged, for example, in a line, as a one-dimensional array, as a bi-dimensional array, in a rectangular form, or in other suitable arrangements. Nozzles 52 may deposit and/or dispense interface material 54. Printing head 8 may also include one nozzle, and in addition multiple printing heads may be used.

In some embodiments, interface material 54 may include photopolymers, such as, for example, DI 7090 Clear Coat, manufactured by Marabuwerke Gmbh & Co., Tamm Germany. Other types of interface material 54 may be used. Preferably, the photopolymer may contain material curable by electromagnetic radiation, such as ultra violet (UV), visible or infra red (IR) radiation. For example, material based on reactive acrylates may be suitable for UV curing or hardening by application of UV radiation from curing unit 56.

In some embodiments, curing may be performed, for example, using curer 56, which may include one or more curing units for curing interface material 54 to form an object (not shown). In one embodiment, curer 56 may include, for example, two curing units; other numbers of curing units may be used. The cured material and/or object may form and/or rest on printing tray 4, which may include a suitable support surface. It is noted that in various embodiments of the invention, other materials may be used (such as materials not being cured using electromagnetic radiation), and other methods of curing may be used. Using 3-D printer 1, an object or a model (not shown) may be built up, typically in layers on printing tray 4.

Controller 62 may be suitably coupled and/or connected to other components of 3-D printer 1. In one embodiment, for example, controller 62 may be connected to curer 56, printing head 8, positioner 51, and leveler 71. In accordance with embodiments of the invention, positioner 51 may move printing head 8 according to commands and/or data from controller 62. Positioner unit 51 may include, for example, motors, servos, guide rails, etc.

Controller 62 may typically accept Computer Object Data (COD) representing an object or a model, such as CAD data in Stereo Lithography (STL) format; other data may be accepted, in other formats. Controller 62 may convert such data to instructions for the various units within 3-D printer 1 to build an object. A controller located within the 3-D printer need not be used. For example, an external control or processing unit (e.g., a personal computer, workstation, computing platform, or other processing device) may provide some or all of the control capability.

In some embodiments, a printing file or other collection of print data may be prepared and/or provided and/or programmed, for example, by a computing platform connected to 3-D printer 1. The printing file may be used to determine the order and configuration of deposition of interface material via, for example, movement of and activation and/or non-activation of one or more nozzles 52 of printing head 8, according to the 3-D model desired to be built.

Controller 62 may be implemented using any suitable combination of hardware and/or software. In some embodiments, controller 62 may include, for example, a processor 64, a memory 66, and software or operating instructions 68. Processor 64 may include conventional devices, such as a Central Processing Unit (CPU), a microprocessor, a “computer on a chip”, a microcontroller, etc. Memory 66 may include conventional devices such as Random Access Memory (RAM), Read-Only Memory (ROM), or other storage devices, and may include mass storage, such as a CD-ROM or a hard disk. Controller 62 may be included within, or may include, a computing device such as a personal computer, a desktop computer, a mobile computer, a laptop computer, a server computer, or workstation (and thus part or all of the functionality of controller 62 may be external to 3-D printer 1). Controller 62 may be of other configurations, and may include other suitable components.

In some embodiments, controller 62 may be internal to and/or integrated within 3-D printer 1; in alternate embodiments, controller 62 may be external and/or partially external to 3-D printer 1, and may communicate with 3-D printer 1, for example, over a wire and/or using wireless communications. In some embodiments, controller 62 may include a CAD system.

Material dispenser 60 may contain one or more interface material(s) 54, and may be suitably connected to printing head 8. In some embodiments, printing tray 4 may be selectively positioned in one or more of the X, Y or Z axes by a positioning apparatus (not shown). In alternate embodiments, printing head 8 may be moved in the Z axis.

In one embodiment, interface material 54 is dispensed using printing head 8, which may typically move in a fixed pattern over the top layer of the object being built. Various patterns may be used, typically involving moving back and forth over the top layer and moving incrementally in one direction at the end of each pass or at the end of a series of passes. For example, in one pattern, printing head 8 may move back and forth in the X direction, forward then reverse, then move a relatively small distance in the Y direction before another set of passes. Other patterns may be used, such as a point-to-point pattern according to COD. A “forward” direction without a corresponding “backward” direction may be used.

In some embodiments, printing head 8 may move forward in the X direction and/or Y direction, depositing interface material 54 in the course of its passage over printing tray 4 in a predetermined configuration. The forward passage of printing head 8 may be followed by curing of the deposited interface material 54. The curing may be performed using a source of electromagnetic radiation, for example, using curer 56. In the reverse passage of printing head 8, back to its starting point for the layer just deposited (e.g., point 0 on the X and Y axes), an additional deposition of interface material 54 may be carried out, according to a predetermined configuration. For example, in the reverse passage of printing head 8, a second part of a layer may be leveled, flattened, pressed and/or straightened by leveler 71, which may include, for example, a roller or other leveling mechanism. Leveler 71 may follow in the path of printing head 8 in its reverse movement; then, the straightened layer may be cured, for example, using curer 56.

In some embodiments, once printing head 8 has returned to the 0 position (e.g., to the starting point) in the X and Y axes, support surface or tray 4 may be lowered in the Z axis to a predetermined height. Alternately, printing head 8 may be moved.

It is noted that other material dispensing methods may be used in accordance with embodiments of the invention. For example, printing head 8 may be static or fixed, and printing tray 4 may be mobile and located below printing head 8, such that nozzles 52 on printing head 8 may be activated in synchronization with the movement of printing tray 4 for accurate positioning of layer deposit.

In some embodiments, electromagnetic radiation is not used for curing, or may not be necessary for curing. For example, some embodiments may use wax as building or modeling material; the wax may cool and solidify on its own due to the drop in temperature of the wax after deposition, and a separate curing process and/or curer 56 may not be required.

In some embodiments, the quality and/or consistency of each layer of interface material deposited may depend on the quality of the printing, which in turn may be dependent on the functioning of nozzles 52. Preferably, deposition of interface material via nozzles 52 is uniform in the consistency and quality of the material being deposited and in voltage intensity; this may allow uniformity of layer thickness for each layer of the model and may result in perfection of the 3-D model being built. However, if, for example, one or more of nozzles 52 selected for activation in the predetermined configuration is faulty or malfunctions, such that interface material is not deposited at all or properly from the nozzle, or the drop volume of interface material is not uniform, then such malfunctioning may result in imperfections in the 3-D model being built. Typically, the drop volume refers to the amount of material dispensed at one time or during a period of time by a nozzle; such material is typically dispensed as a drop, but need not be. Thus, in one embodiment, drop volume refers to the amount of material in a drop dispensed by a nozzle.

Embodiments of the invention provide devices and methods to allow, for example, detection of one or more malfunctioning or missing nozzles 52, calibration of one or more nozzles 52, optimization and/or enhancement and/or improvement of the operation of one or more nozzles 52, and/or automatic and/or adaptive and/or dynamic modification of one or more properties related to the operation of one or more nozzles 52.

During operation of 3-D printer 1, printing head 8 may deposit interface material 54 onto printing tray 4 to create one or more measuring blocks or groups; for example, measuring blocks 111 to 117 may be created. Measuring blocks 111 to 117 may include one or more measuring blocks made of model material, and/or one or more measuring blocks made of support material. For example, printing head 8 may deposit interface material to create one or more measuring blocks of support material and one or more measuring blocks of model material. Other numbers of measuring blocks may be used, and other combinations of measuring blocks made of support material and/or model material may be used. It is noted that measuring blocks may have various suitable shapes, sizes, dimensions, weight, volume, height, layer thickness, and/or properties.

In some embodiments which include height/distance sensor 96, height/distance sensor 96 may include one or more suitable sensors, for example, an optical sensor, an acoustic sensor, or any other suitable sensor device able to detect and/or measure height and/or distance. In one embodiment, height/distance sensor 96 may use a beam 97 (e.g., an electromagnetic radiation beam, an ultrasonic beam, etc.) to measure height and/or distance; other suitable methods may be used. Height/distance sensor 96 may be located, for example, in a suitable location of printing head 8, or in a suitable location adjacent to printing head 8, to allow height/distance sensor 96 to move together with printing head 8 and to vertically scan and/or measure the height and/or distance of measuring blocks, preferably one measure block at a time, while moving with printing head 8.

In some embodiments which include transmitter 91 and receiver 92, transmitter 91 and receiver 92 may be located externally to 3-D printer 1 and may operate as a horizontal height/distance sensor. For example, transmitter 91 may transmit a beam 98 (e.g., an electromagnetic radiation beam, an ultrasonic beam, etc.) towards receiver 92; successful and/or complete reception of beam 98 by receiver 92 may indicate that one or more of measuring blocks 111 to 117 are not high enough to block beam 98; unsuccessful and/or incomplete reception of beam 98 by receiver 92 may indicate that one or more of measuring blocks 111 to 117 are high enough to block beam 98. In some embodiments, transmitter 91 and/or receiver 92 may be implemented using a transceiver and/or a transmitter-receiver, and may be static and/or moving components.

In alternate embodiments, a mechanical system (not shown) of height and/or distance measurement may be used. Such a mechanical system may be a part of 3-D printer 1, or may be positioned within 3-D printer 1 or in proximity to it. Alternatively, such a mechanical system may be external to 3-D printer 1. In some embodiments, the system may be used to manually and/or automatically measure height and/or distance of one or more of measuring blocks 111 to 117.

3-D printer 1 may optionally include one or more units for interface material weight measurement. In some embodiments, such units may be external to 3-D printer 1 and may not form a fixed part of 3-D printer 1, for example, laboratory type weight scales or other types of weight measurement scales which may or may not be attached to 3-D printer 1. Alternatively, one or more units for interface material weight measurement may be included in 3-D printer 1, for example, in the form of a trough or other suitable container which may be attached to a weight scale. For example, in one embodiment, a trough or other suitable container may be attached to a load cell, which in turn may be connected to 3-D printer 1 and/or to controller 62. In some embodiments, the load cell may include, for example, a device that when mechanically stressed, may change one or more of its electrical characteristics (e.g., resistance) thus allowing, for example, weight measurement.

One or more weight scale(s) 99 may be used to measure the weight of one or more of measuring blocks 11 to 117. The measured weight may be used, for example, for comparison purposes and/or analysis of drop weight, layer weight, drop volume and/or layer volume. In some embodiments, weight scale(s) 99 may be positioned on printing tray 4, under printing tray 4, or may be a part of printing tray 4.

Alternatively, weight scale(s) 99 may be external to 3-D printer 1, allowing printing head 8 to deposit measuring blocks in any suitable volume and on any suitable surface. Measuring blocks may then be placed, automatically or manually, on weight scale(s) 99, allowing weight scale(s) 99 to weigh one or more measuring blocks, and/or allowing weight scale(s) 99 to compare the weight of one or more measuring blocks against other one or more measuring blocks or against a reference weight value.

It is noted that in some embodiments, the range of weight of one or more measuring blocks may be, for example, between 0.1 gram to 1 gram, or a few grams; various embodiments may measure and/or result in other ranges of weight for one or more measuring blocks.

In some embodiments, the thickness of a layer of deposited interface material may be proportional, or substantially proportional, to the drop-volume or the drop-weight of the deposited interface material. In some embodiments, the drive voltage applied to a nozzle 52 (e.g., to a piezoelectric transducer of a nozzle 52) may control, for example, drop-volume or drop-weight of interface material deposited using that nozzle 52. In accordance with some embodiments of the invention, determination of layer thickness and/or determination of drop-volume or drop-weight, may allow modification of a drive voltage applied to one or more nozzles 52. This may allow, for example, uniform or substantially uniform drop-volume or drop-weight over a plurality of nozzles 52, or over all or substantially all nozzles 52.

In one embodiment, for example, it may be desired that non-uniformity in drop-volume or drop-volume of various nozzles 52 may not exceed five percent; other percentage values of pre-defined threshold values may be used. The calibration and optimization process in accordance with some embodiments of the invention may allow, for example, achieving a desired level of uniformity, or to reduce a level of non-uniformity to even below five percent or other suitable values.

In accordance with some embodiments, one or more nozzles 52 may be separately calibrated and/or optimized. For example, a measuring block may be deposited by one nozzle 52; one or more properties of the measuring block (e.g., height, thickness, distance, or weight) may be measured; a drop-volume or drop-weight may be calculated for that nozzle 52; and a drive voltage applied to that nozzle 52 may be modified to allow a desired modification of drop-volume or drop-weight deposited by that nozzle 52. In some embodiments, similar operations may be performed substantially in parallel and/or substantially simultaneously, for example, to calibrate and/or optimize a plurality of nozzles 52, or all or substantially all nozzles 52 of one or more printing heads 8. In one embodiment, for example, the process may be applied to a group of nozzles 52, or to an entire printing head 8.

In some embodiments, 3-D printer 1 may optionally include an imager 95. Imager 95 may include, for example, a suitable scanner, camera, digital camera, video camera, still camera, reader, Charge-Coupled Device (CCD), CCD-based device, optical sensor, or another suitable image acquisition device. In some embodiments, imager 95 may be used, for example, to acquire one or more images of an object being created, of measuring blocks, of test patterns, and/or of various other results of the operation of 3-D printer 1. In some embodiments, imager 95 may be connected to controller 62, and may transfer image data to controller 62 for storage, processing and/or analysis. In some embodiments, imager 95 may be connected to and/or associated with an illumination unit 94. Illumination unit may include a suitable light source (e.g., a light bulb) to provide illumination for acquisition of images.

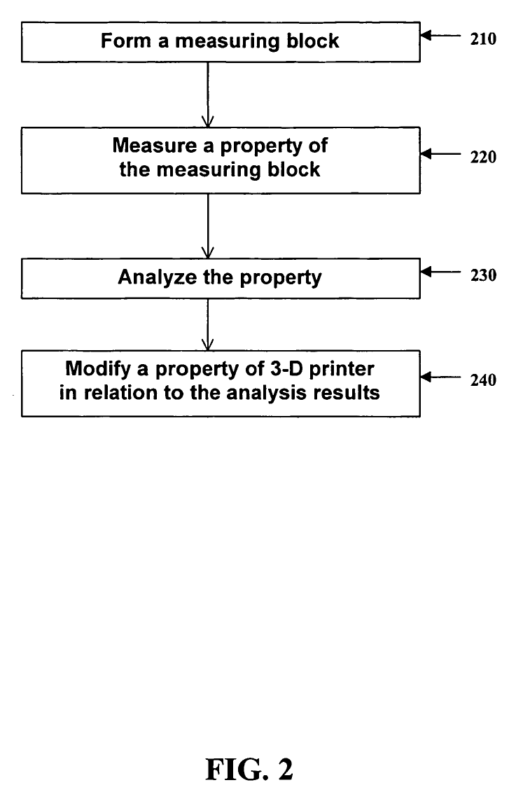

FIG. 2 is a flow chart diagram of a method of calibration of a 3-D printer according to an embodiment of the present invention. The method of FIG. 2 may be used, for example, with 3-D printer 1 of FIG. 1 and/or with other suitable 3-D printers.

As indicated at block 210, one or more measuring blocks may be formed. For example, in some embodiments, printing head 8 may deposit one or more layers of interface material 54 onto printing tray 4. In some embodiments, a plurality of measuring blocks may be deposited, according to a pre-defined configuration and/or alignment, and the interface material 54 may include model material and/or support material. In some embodiments, a measuring block may include only support material, or only modeling material, or a suitable combination of support material and modeling material. It is noted that in some embodiments, forming a measuring block may include, for example, depositing and/or repeatedly depositing one or more layers of interface material 54 and curing the deposited layer of interface material 54; the curing may include, for example, the application of electromagnetic radiation, or other suitable curing operations as described.

In some embodiments, measuring blocks may have various suitable shapes, dimensions and/or sizes, for example, to allow further detection, sensing and/or acquisition to determine that one or more nozzles 52 may be non-functional, defective, blocked or dysfunctional.

In some embodiments, the pre-defined configuration of deposition of interface material 54 may be, for example, in the form of a printing file which may be prepared and/or provided in advance; such printing file may include data and/or instructions indicating activation and/or non-activation of one or more nozzles 52, or one or more groups of nozzles 52, in pre-determined locations on printing tray 4. Alternately, such a printing file or printing sequence may be controlled by or stored by controller 62.

It is noted that in some embodiments, interface material 54 may be deposited onto printing tray 4 by one or more nozzles 52 or by one or more groups of nozzles 52, separately, consecutively, repeatedly, in parallel, and/or substantially simultaneously, to form one or more measuring blocks.

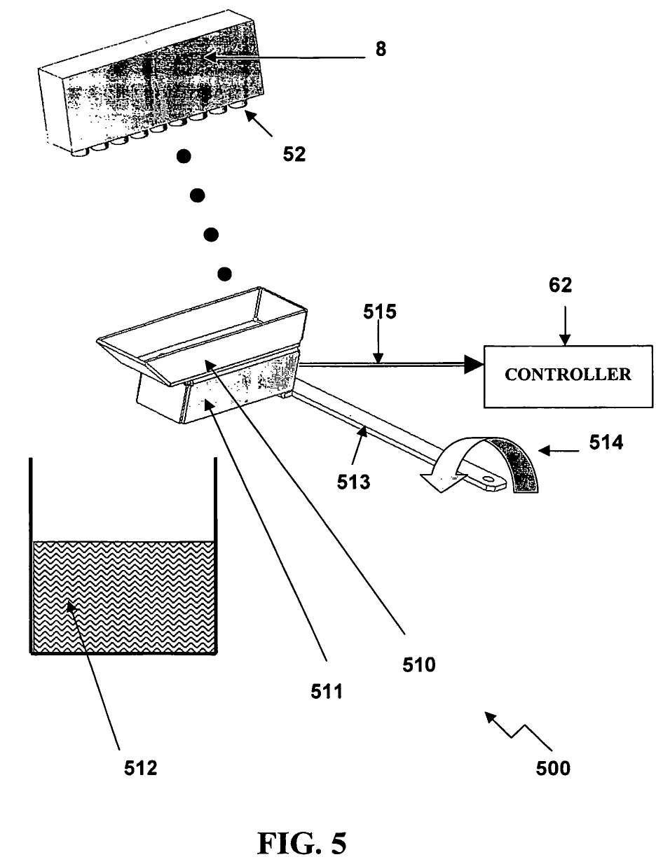

It is noted that in some embodiments, for example, in the embodiment of FIG. 5, measuring blocks need not be formed, and interface material may be deposited, for example, into a container or a trough to be weighed or otherwise analyzed in a liquid form.

As indicated at block 220, a property of the measuring block or of more than one measuring blocks may be measured. The property may include, for example, the height of the measuring block(s) above printing tray 4, the thickness of the measuring block(s), the distance of the measuring block(s) from a component or an object, the weight of the measuring block(s), the volume of the measuring block(s), the size of the measuring block, one or more dimensions of the measuring block(s), or any other suitable property. In some embodiments, the measurement may be absolute, e.g., may provide the actual value of the property being measured; in alternate embodiments, the measurement may be differential, e.g., may provide the difference between the value of the property being measured and a reference value or a value of a property of another measuring block.

In some embodiments, measuring the property may include, for example, detecting, scanning, weighting, sensing, calculating, and/or a combination of one or more suitable operations. The measurement may be performed, for example, using height/distance sensor 96, using transmitter 91 and receiver 92, using a mechanical device or system as described, using one or more weight scales as described, and/or using another suitable device and/or component. It is noted that in some embodiments, interface material 54 may optionally be weighed in liquid form, instead of or in addition to other measurements being performed.

As indicated at block 230, the measured property may be analyzed. The analysis may include, for example, comparing the value of the measured property to one or more pre-defined reference values, or to a value of a property of another measuring block. In some embodiments, the analysis may include producing data, for example, data indicating drop volume, data indicating thickness of the deposited interface material 54, data indicating layer thickness, data indicating over-driving voltage of one or more depositing nozzles 52, data indicating under-driving voltage of one or more depositing nozzles 52, or other suitable data. In some embodiments, the analysis may include producing data indicating differences in drop volume and/or layer thickness between measuring blocks.

In some embodiments, the analysis may include calculating the variation in height of each measuring block from a reference level and/or a reference value and/or a reference height. Furthermore, the analysis may include determining improved and/or optimum jetting parameters for one or more nozzles or groups of nozzles.

In some embodiments, the analysis may be performed, for example, using controller 62, using 3-D printer 1, and/or using a dedicated or multi-purpose analysis unit. The analysis unit may receive measurement data directly from measuring components, which may be linked and/or connected to it; alternatively, the analysis unit may receive measurement data in other suitable methods, for example, by receiving data entered manually into a computing platform.

As indicated at block 240, a property related to the operation of the 3-D printer may be modified in relation to the analysis results. For example, in some embodiments, a property related to the operation of one or more printing heads 8, and/or one or more nozzles 52, may be modified. Furthermore, in some embodiments, one or more jetting parameters and/or properties of one or more printing heads 8 and/or nozzles 52 may be modified in relation to the analysis results. Such jetting parameters or properties may include, for example, jetting head temperatures, jetting pulse voltage, nozzle voltage, printing head voltage, jetting pulse shape, jetting frequency, distance of the nozzle from printing tray 4, printing tray 4 temperatures, and/or other suitable parameters or properties.

For example, if the analysis detected over-driving or under-driving voltage of a nozzle 52, the driving voltage of that nozzle 52 may be decreased, increased and/or otherwise modified to allow adequate compensation and/or improved operation of that nozzle. It is noted that data, analysis results and/or information related to modification in the operation and/or properties of one or more nozzles 52, may be stored and/or maintained in memory (e.g., memory 66). In some embodiments, controller 62 may receive such data, and/or may produce suitable instructions taking such data into account. For example, based on such data, controller 62 may produce instructions related to movement and/or positioning of printing head 8, timing of firing actions and/or sequence, amount of interface material 54 deposited per drop, etc. In one embodiment, for example, controller 62 may provide instructions to increase the driving voltage of a nozzle found to be under-performing. Other suitable instructions may be used.

In some embodiments, various printing heads 8 and/or nozzles 52 may have various driving voltages, for example, depending on the type and/or manufacturer of the printing heads 8 and/or nozzles 52. In some embodiments, the driving voltage may vary between 24 and 40 volts, may have a drop-volume to voltage sensitivity of approximately 4 Pico-liter per volt, and a layer height sensitivity of approximately 1 micrometer per volt. In other embodiments, driving voltage may vary between 60 and 140 volts, may have a drop-volume to voltage sensitivity of approximately 1.5 Pico-liter per volt, and a layer height sensitivity of approximately 0.3 micrometer per volt. It is noted that these values are presented for exemplary purposes only; other values may be used, and the scope of the invention is not limited in this respect. It is further noted that, in some embodiments, modifying a voltage may modify the amount of material deposited, or may otherwise affect the results of the deposit operation.

Additionally or alternatively, the analysis results may indicate that a nozzle 52 is partially or completely blocked or non-functional. In such case, correcting and/or compensating operations may be performed, to compensate for the malfunctioning nozzle 52, to fix the malfunctioning, or to otherwise modify the operation of one or more nozzles 52 to allow improved operational results. For example, the analysis may indicate a location of a blocked nozzle 52 or a non-functional nozzle 52; in such case, compensating operations may include treatment of the blocked or non-functional nozzle 52 using unblocking treatments, such as liquid purging or a heating cycle. A malfunctioning or blocked nozzle may be treated according to known methods in response to an analysis.

In various embodiments, similar or other operations may be performed in relation to the analysis results. For example, one or more nozzles 52 may be marked and/or identified as “missing”, “non-functional”, “malfunctioning”, etc., and various compensating operations may be performed accordingly. In some embodiments, alternative functioning nozzles 52 may be activated to compensate for a malfunctioning or non-functional nozzle 52; other compensatory operations may be used, including, for example, according to compensatory algorithms pre-programmed into the 3-D printer or to its computing platform, for example, using controller 62. In some embodiments, data related to malfunctioning nozzles 52 may be taken into account by controller 62, for example, as controller 62 produces instructions related to movement and/or positioning of printing head 8, timing of firing actions and/or sequence, amount of interface material 54 deposited per drop, etc.

In some embodiments, measuring the property of the measuring block may include measuring the height of the measuring block. This may be performed using a suitable component, for example, using height/distance sensor 96, using transmitter 91 and receiver 92, using a mechanical device or system as described herein, or using other suitable components. The height of the measuring block may be measured for comparison relative to a pre-determined reference level. In some embodiments, the reference level may be a “ground” level height or a “point 0” of the printing tray 4. The height difference between a measuring block and the reference level may be transferred, automatically and/or manually, to controller 62, for analysis and/or calculation of compensatory operations to be taken.

Furthermore, measuring the height, weight, volume, size, dimensions, thickness, and/or other suitable properties of one or more measuring blocks relative to a reference level, may result in information about one or more nozzles 52 of printing head 8 for purposes of calibration. For example, the layer thickness of interface material deposited by one or more nozzles 52 may be calculated. In addition, malfunctioning or blocked nozzles 52 may be located on printing head 8. It is noted that in some embodiments, one or more nozzles 52 or blocks produced by nozzles may be interlaced in a suitable resolution, for example, to allow analysis of one nozzle 52 or of a plurality of nozzles 52.

In some embodiments, one or more nozzles 52 may be graded or evaluated based on the measurements and/or the analysis performed. In one embodiment, according to drop-weight data, controller 62 may grade one or more nozzles 52 as, for example, “good quality”, “low weight”, “non-functional”, “missing”, etc. This grade data may be used, for example, as input to a layer-thickness optimization process, which may be performed upon an indication that a calibration is requested and/or required. For example, a relatively high drop-weight calculated for a nozzle 52, may prompt the process to decrease the driving voltage of that nozzle 52. In some embodiments, driving voltage of a nozzle 52 may be calculated, set and/or modified based on, and may be proportional to, the drop-weight calculated for that nozzle 52 as described above.

Using the embodiment of the method of FIG. 2 may allow, for example, detection of inaccurate deposition of interface material 54 and/or location of malfunctioning components of a 3-D printer, therefore allowing compensation for such inaccurate deposition or malfunctioning in subsequent use of the 3-D printer to achieve maximum uniformity in the 3-D model being constructed. In some embodiments, the method of calibration may include detection, measurement, collection, storage and/or gathering of information related to the functioning of one or more nozzles on a printing head. This may allow optimizing the jetting parameters and/or the properties of one or more nozzles 52 and/or printing heads 8, thus producing a more accurate 3-D model. Some embodiments may allow substantially uniformity of drop-weight and/or drop-volume produced by a plurality of nozzles 52, or by substantially all nozzles 52, of a printing head 8 or of a 3-D printer, thus allowing uniformity of layer-thickness and/or improved quality of the final model. For example, in one embodiment, a nominal-weight bar may be printed, may be weighted manually and/or automatically (e.g., using weight scales); the weight data may be entered manually, or transferred automatically, to controller 62 for further calculations and/or analysis.

In an exemplary analysis according to some embodiments, a lesser height and/or weight and/or volume of a measuring block may indicate insufficient deposition of interface material 54 from one or more nozzles 52; and a greater height and/or weight and/or volume of a measuring block may indicate excessive deposition of interface material 54 from one or more nozzles 52. Therefore, in some embodiments, a drop volume and/or a layer thickness may be increased or decreased, respectively, to compensate for the analysis results. Other compensatory and/or correction operations may be used, for example, modifying a driving voltage of one or more nozzles 52.

In another exemplary analysis according to some embodiments, a blocked nozzle 52 or a “missing” nozzle 52 may be located on printing head 8, as indicated by blank or missing measuring block. In some embodiments, a signal or a message may be provided to a user, for example, to indicate and/or identify one or more malfunctioning nozzles 52 or printing heads 8. A user may receive such signal or message, and may manually perform, or instruct to perform, various treatment operations, replacement operations, compensating operations, correcting operations, properties modification operations, and/or suitable adjustment operations. Alternatively, such operations may be performed automatically by the 3-D printer, based on the analysis results. In some embodiments, a blocked nozzle 52 may be treated, for example, using liquid purging or heating cycle to unblock the blocked nozzle 52. Additionally, or if such treatments do not succeed in unblocking a nozzle 52, the blocked nozzle 52 may be marked and/or defined as non-functional in the suitable component, for example, in controller 62 and/or 3-D printer 1. Furthermore, a pre-programmed compensatory algorithm may be used to compensate for a missing and/or blocked nozzle 52 in the process of regular 3-D model building. For example, a compensatory algorithm may be implemented to overcome or replace a missing nozzle 52 with other functioning nozzles 52 on one or more printing heads 8.

Similarly, if a nozzle 52 is significantly under-functioning, as indicated by significantly lower height and/or weight and/or volume and/or layer-thickness measurements of one or more measuring blocks, then such nozzle 52 may also be defined as “missing” or non-functioning, and may be compensated for similarly to a blocked nozzle 52 which has not successfully responded to unblocking treatments.

Furthermore, in some embodiments, the method of FIG. 2 may be performed automatically, repeatedly, and/or periodically. For example, 3-D printer 1 may perform self-calibration, upon request by a user, or automatically when a trigger event occurs. Such trigger event may include, for example, elapsing of a pre-defined period of time since a previous calibration or since a previous maintenance operation, production of a pre-defined number of models since a previous calibration, or other events which may trigger self-calibration. In some embodiments, self-calibration may include performing operations in accordance with the method of FIG. 2.

In some embodiments, the analysis performed in the method of FIG. 2 may include evaluating the functionality of one or more printing heads 8; for example, evaluating whether a printing head 8 may function reasonably and/or adequately if one or more of its properties, or its nozzle properties, is modified. The evaluation may include, for example, printing a test pattern, acquiring an image of the test pattern, analyzing the acquired image, and modifying one or more properties of a printing head 8 and/or of one or more nozzles 52. In one embodiments, such analysis may result in notification of the need to replace printing head 8, and automatic or manual replacement of printing head 8.

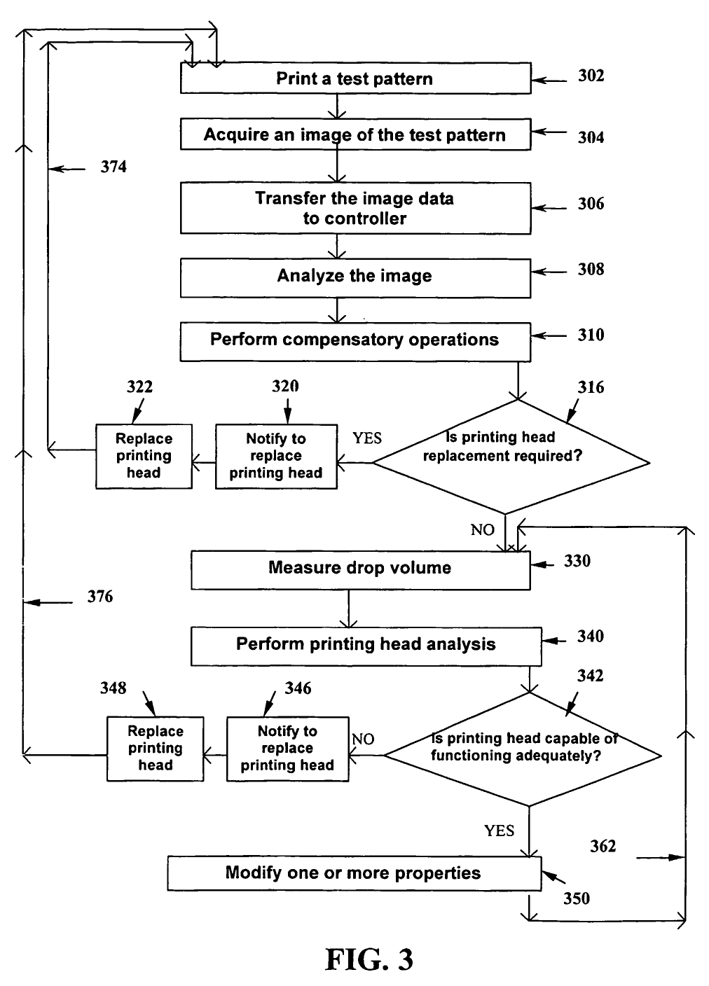

FIG. 3 is a flow chart diagram of a method of optimization according to an embodiment of the present invention. The method of FIG. 3 may be used, for example, with various 3-D printers in accordance with embodiments of the invention, as well as other suitable 3-D printers. It is noted that the method of FIG. 3 may be a detailed implementation of the method of FIG. 2.

As indicated at block 302, a test pattern may be printed, for example, using 3-D printer 1 onto a substrate. The substrate may include, for example, printing tray 4 or any other suitable tray or support surface. The substrate may be fixed within 3-D printer 1, or may be detachable and/or removable from 3-D printer 1. In some embodiments, the test pattern may be bi-dimensional, such that it may include a single layer of interface material 54. The test pattern may include one or more pre-defined geometric figures for one or more of nozzles 52 of printing head 8. In one embodiment, the test pattern may include a geometric figure for each of the nozzles 52 of printing head 8. The geometric figure may include, for example, a rectangle, a square, a circle, a diamond shape, an oval, or other suitable shapes in pre-defined sizes and/or dimensions. In other embodiments, each nozzle 52 may individually print a test pattern, which may be individually evaluated and/or analyzed, before another nozzle 52 prints a test pattern.

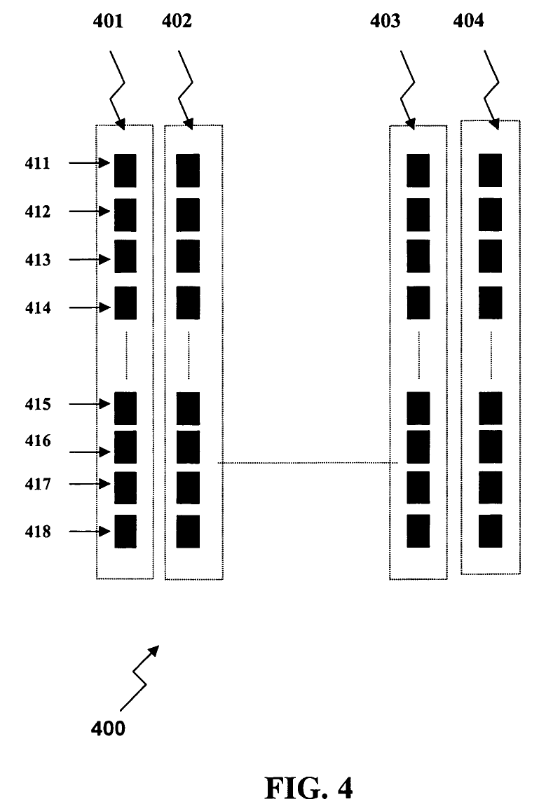

Reference is now briefly made also to FIG. 4, which is a schematic illustration of an exemplary test pattern 400 according to an embodiment of the present invention. Test pattern 400 may include one or more sets of geometric figures, for example, sets 401, 402, 403 and 404. Each of these sets may correspond to a printing performed by a different printing head 8, and may include a set of nozzle features. For example, set 401 may include nozzle features 411, 412, 413, 414, 415, 416, 417 and 418. In various embodiments, other number of sets and/or nozzle features may be used, and other numbers of printing heads 8 and/or nozzles 52 may be activated. Furthermore, different sets may include different numbers, shapes and/or sizes of nozzle features, and different printing heads 8 may produce different sets of nozzle features.

Referring back to FIG. 3, as indicated at block 304, an image of the generated test pattern may be acquired. The image acquisition may be performed, for example, using a scanner, a camera, a digital camera, a video camera, a still camera, a reader, a Charge-Coupled Device (CCD), a CCD-based device, an optical sensor, or another suitable image acquisition device. For example, the image acquisition may be performed using imager 95.

As indicate at block 306, the acquired image, or data representing the acquired image, may be transferred to controller 62. As indicated at block 308, the acquired image may be analyzed, for example, using controller 62. The analysis may include detection of a missing nozzle 52, a non-functional nozzle 52, and/or a malfunctioning nozzle 52. The analysis may further include registration, identification and/or indication of one or more nozzles 52 as missing, non-functional and/or malfunctioning. In some embodiments, the analysis may be performed for one or more nozzles 52, sets of nozzles 52, and/or printing heads 8.

In some embodiments, the analysis may include evaluation of the quality, the performance and/or the operation of one or more printing heads 8. The evaluation may be, for example, in relation to the number and/or the percentage of nozzles 52 identified as missing, non-functional and/or malfunctioning. For example, in one embodiment, a printing head 8 in which ten percent of the nozzles 52 are missing, non-functional and/or malfunctioning may be graded and/or identified as a non-functional printing head 8 which requires replacement. Other percentage values may be used, and other numbers of nozzles 52 may be used.

Additionally or alternatively, the evaluation may take into account the distribution, the relative distribution and/or the absolute distribution, of missing, non-functional and/or malfunctioning nozzles 52 across a printing head 8 and/or across an area on a printing head 8. The analysis may evaluate the scatter pattern of the missing, non-functional and/or malfunctioning nozzles 8. For example, a printing head 8 that includes a cluster and/or group of several adjacent missing, non-functional and/or malfunctioning nozzles 52 (e.g., four adjacent nozzles 52), may be graded and/or identified as a non-functional printing head 8 which requires replacement. Alternatively, a printing head 8 that includes, for example, nine missing, non-functional and/or malfunctioning nozzles 52 which are substantially uniformly scattered and non-adjacent among themselves, may be regarded and/or identified as a functional printing head 8 which does not require replacement. Other percentage values may be used, and other numbers of nozzles 52 may be used.

As indicated at block 310, compensatory operations may be performed in relation to the analysis results. Compensatory operations may include, for example, modifying a property of one or more nozzles 52, or modifying a property of printing head 8. In one embodiment, for example, a voltage of one or more nozzles 52 may be modified, or a voltage of printing head 8 may be modified. In alternate embodiments, one or more nozzles 52 may be treated, for example, to remove blockage. In some embodiments, one or more nozzles 52 may be activated to compensate for one or more other nozzles 52 which may be malfunctioning or non-functional. Various other compensatory operations may be used.

As indicated at block 316, based on the analysis and/or on the results of the compensatory operations, a determination may be made as to whether replacement of printing head 8 is required or not. If replacement is required, then, as indicated at block 320, a notification and/or an indication may be produced of the need to replace one or more printing heads 8. For example, a display or indicator on or associated with 3-D printer 1 may indicate replacement is needed. Furthermore, as indicated at block 322, one or more printing heads 8 may be replaced, automatically or manually. Additionally or alternatively, other compensatory operations may be performed, for example, assignment of one or more nozzles 52 to be activated instead of other one or more missing, malfunctioning and/or non-functional nozzles 52.

As indicated at block 330, a drop-volume of deposited interface material 54 may be measured. This may be performed, for example, using reservoir 400 and/or level sensor 403 as described herein with reference to FIG. 4. Additionally or alternatively, other methods to measure drop-volume may be used in accordance with embodiments of the invention, or other suitable properties may be measured.

As indicated at block 340, in relation to the drop-volume measurement results, a printing head analysis may be performed. In some 3-D printers, printing head performance may degrade over time, for example, due to partially-clogged nozzles and/or partially blocked fluid passages in the printing head. The printing head analysis in accordance with embodiments of the invention may indicate a decrease in the drop-volume produced by one or more nozzles 52. It is noted that in one embodiment, a drop-volume greater or equal than 90 Pico-liter may indicate adequate performance of the nozzle producing that drop-volume; however, other values may be used, for example, in relation to the minimum layer height as defined and/or required by a specific implementation of a 3-D printer.

As indicated at block 342, the printing head analysis may include evaluating the capability of a printing head 8 to reach a pre-defined performance level, by temporarily modifying one or more properties of printing head 8 and/or of one or more of its nozzles 52, for example, by increasing and/or modifying the drive voltage to nozzles 52 of that printing head 8. If the evaluation result is that printing head 8 may still malfunction with such modifications, then, as indicated at block 346, a notification and/or an indication of the need to replace printing head 8 may be produced; furthermore, as indicated at block 348, printing head 8 may be replaced, automatically or manually.

Alternatively, if the evaluation result is that printing head 8 may function adequately and/or reasonably using modified one or more properties, then a replacement of printing head 8 may not be required. Instead, as indicated at block 350, the one or more properties may be modified; for example, the drive voltage of printing head 8, or of one or more of its nozzles 52, may be increased, adjusted and/or modified. Other properties of printing head 8 and/or one or more of its nozzles 52 may be modified.

Optionally, as indicated by arrow 662, after modification of a property of printing head 8, the method may partially repeat by performing again operations starting with the drop-volume measurement of block 330.

Optionally, as indicated by arrow 374 and arrow 376, after replacement of a printing head, the method may repeat by performing again operations starting with printing the test pattern of block 302. Other steps and series of steps may be used and, further, an embodiment of the invention need not include all steps shown in FIG. 2 or FIG. 3.

It is noted that the method of FIG. 3 may be applied, for example, to one or more printing heads in a 3-D printer, and/or may be applied to a plurality of printing heads consecutively and/or substantially in parallel. In some embodiments, the method may be applied individually to each of the printing heads of a 3-D printer. Furthermore, the method may be performed automatically, for example, on a periodic basis. It is also noted that specific features of the various embodiments described herein may be combined. For example, aspects the embodiment of the invention as described with respect to FIG. 2 may be used with that described in FIG. 3.

It would be appreciated that in accordance with embodiments of the invention, other measurements, analyses, parameters and/or criteria may be used for evaluation of a printing head of a 3-D printer. In some embodiments, other compensatory operations, correcting operations, notifications, replacements, property modifications and/or property adjustments may be performed in relation to the results of such evaluation.

Uniformity of layer thickness of deposited material may allow obtaining, for example, a good surface quality of a 3-D model. In accordance with embodiments of the invention, this may be achieved, for example, by calibrating nozzles 52 and/or evaluating printing heads 8, as described. Some embodiments may substantially allow uniformity of drop-weight and/or drop-volume produced by a plurality of nozzles 52, or by substantially all nozzles 52, of a printing head 8 or of a 3-D printer. For example, the method of FIG. 2, the method of FIG. 3, and/or other suitable methods in accordance with embodiments of the invention, may be used to equalize the drop-weight and/or drop-volume produced by one or more, or all, nozzles 52 in a printing head 8 or in a 3-D printer, and/or to improve and/or optimize layer thickness. In some embodiments, this may be achieved, for example, by modifying and/or adjusting one or more properties, e.g., drive voltage, of one or more nozzles 52.

In some embodiments, it may be possible to modify and/or adjust a property (e.g., voltage) for an entire printing head 8, and not to one nozzle 52 or a selected group of nozzles 52. In such case, the calibration process may take into account the status of one or more nozzles 52 when calculating layer thickness.

In accordance with embodiments of the invention, a 3-D printer may include a plurality of printing heads 8 which may have identical, similar and/or different properties or operations. In some embodiments, a characterization process may be performed for a printing head 8, for example, during its production process. The characterization process may include writing data into a designated non-volatile memory within printing head 8 or, for example, into a controller or memory or storage device in a 3-D printer into which printing head 8 is to be installed. The data may include, for example, a serial number of printing head 8, a production date and/or time, and various suitable parameters, values and/or ranges. The data may further include, for example, drop-weight values or ranges, drop-volume values or ranges, voltage values or ranges, temperature values or ranges, drop-weight versus voltage curve data, and other data indicating various properties of printing head 8 and/or of its individual nozzles 52 and/or components. This data may be taken into account during the optimization, calibration and/or evaluation processes in accordance with embodiments of the invention.

FIG. 5 is a schematic illustration of a calibration system according to an embodiment of the present invention. System 500 of FIG. 5 may be used, for example, in conjunction with 3-D printer 1 of FIG. 1, with the method of FIG. 2 or FIG. 3, with various other devices and/or methods in accordance with embodiments of the invention, and/or with various other 3-D printers and/or 3-D printing methods.

System 500 may include, for example, printing head 8, nozzles 52, controller 62, a container or trough 510, a load cell 511, a waste container 512, and a movement mechanism 513. System 500 may include other suitable components of 3-D printer 1 of FIG. 1, and/or of various other 3-D printers; in some embodiments, system 500 may be an integral and/or internal part of such 3-D printers.

When system 500 is not operational, it may be manually or automatically stored and/or positioned within an area of the 3-D printer such that system 500 does not interfere with the regular operation of the 3-D printer, and does not block or interfere with a creation of an object. When a calibration process begins, system 500 may be moved, manually or automatically (for example, using movement mechanism 513) to a suitable position to allow calibration, e.g., such that the container or trough 510 is located underneath printing head 8. When a calibration process ends, system 500 may be moved back to its previous, non-interfering position.

Trough 510 may include, for example, any suitable cup, tray, trench, and/or container able to receive, accumulate and/or collect interface material 54 deposited towards it. Load cell 511 may include, for example, a suitable weight scale and/or weight sensor able to measure and/or calculate a weight of an object placed on load cell 511. Waste container 512 may include, for example, any suitable container able to receive, accumulate and/or collect materials disposed into it. Movement mechanism 513 may include, for example, a suitable rod or beam able to hold, support, move and/or rotate an object connected to it, such as load cell 511 and/or trough 510.

In some embodiments, trough 510 may be mounted on load cell 511 or may be mechanically attached to load cell 511, for example, to allow load cell 511 to measure the weight of trough 510 and its contents. Waste container 512 may be located substantially underneath trough 510 or an edge of trough 510, for example, to allow pouring of material from trough 510 into waste container 512 upon suitable rotation of trough 510.

Controller 62 may initiate a sequential “firing”, e.g., activation or printing, using one or more nozzles 52. For example, one nozzle 52 may be fired at a time, such that each of a group of nozzles 52 may be fired individually in turn. The sequential firing may be performed, for example, in accordance with a pre-defined printing file.

Trough 510 may receive, accumulate and/or collect the drops of interface material 54 being fired. Load cell 511 may measure the weight of trough 510 and its contents (“total weight”). In some embodiments, the weight of the contents of trough 510 (“contents weight”) may be calculated; this may be performed, for example, using load cell 511, using controller 62, manually, or using another suitable device to calculate the difference between the weight of trough 510 in an “empty” condition and the total weight of trough 511 and its contents.

Load cell 511 may transfer to controller 62 the total weight and/or the contents weight. In some embodiments, the transfer may be performed automatically and/or in real-time, for example, using a wired and/or wireless link 515 between load cell 511 and controller 62. In alternate embodiments, the transfer may be performed manually, for example, by removing trough 510, weighting it to calculate its total weight and/or its contents weight, and feeding weight data into controller 62.

In some embodiments, layer thickness of deposited material may be proportional to drop volume and/or drop weight. Controller 62 may analyze the weight data, and may calculate drop-weight data for one or more nozzles 52. In some embodiments, controller 62 may calculate drop-weight data for each nozzle 52 individually. For example, each nozzle 52 may be individually moved and/or positioned over trough 510, and may deposit interface material 54 into trough 510, to allow a separate weighing for the deposit of each nozzle 52, and to allow a separate evaluation of each nozzle 52. Between such separate nozzle evaluations, the contents of trough 510 may be discarded, for example, into waste container 512.

After weight measurements are performed, the contents of trough 510 may be transferred to waste container 512. This may be performed, for example, by moving and/or rotating movement mechanism 513 which may be mechanically connected to trough 510 and/or load cell 511, in a rotation direction indicated by arrow 514, to allow the contents of trough 510 to spill and/or fall into waste container 512. Other methods and/or components may be used to empty trough 510, to clean trough 510, or to otherwise dispose of the contents of trough 510. Such disposal may be performed, for example, automatically, manually, and/or periodically.

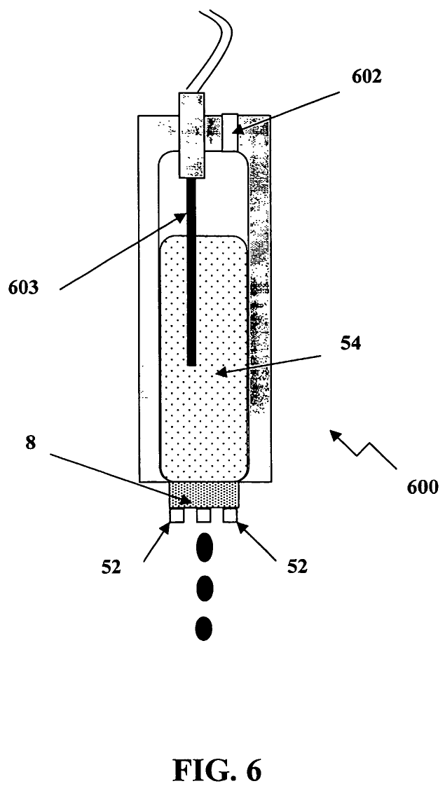

FIG. 6 is a schematic illustration of a reservoir according to an embodiment of the present invention. Reservoir 600 of FIG. 6 may be used, for example, in conjunction with 3-D printer 1 of FIG. 1, with the method of FIG. 2, with the method of FIG. 3, with various other devices and/or methods in accordance with embodiments of the invention, and/or with various other 3-D printers and/or 3-D printing methods.

Reservoir 600 may store and contain interface material 54 prior to its deposit. In some embodiments, interface material 54 may be stored inside reservoir 600 as a fluid and/or in a liquid form. Interface material 54 may be inserted into reservoir 600 using, for example, an inlet 602, which may be located at the top of reservoir 600. Reservoir 600 may be attached to printing head 8, which may include nozzles 52; in some embodiments, reservoir 600 may be an integral part of printing head 8.

In some embodiments, reservoir 600 may include a level sensor 603. Level sensor 603 may include, for example, a fluid level sensor, a liquid level sensor, or another suitable sensor able to detect and/or measure the level and/or height and/or volume of interface material 54 within reservoir 600.

Reservoir 600 may be filled with interface material 54, to the maximum capacity of reservoir 600 or to a pre-defined percentage of its capacity. Then, a sequential “firing”, e.g., activation or printing, may be initiated using one or more nozzles 52. For example, one nozzle 52 may be fired at a time, such that each of a group of nozzles 52 may be fired individually in turn. The sequential firing may be performed, for example, using controller 62 and/or in accordance with a pre-defined printing file.

As interface material 54 is fired or deposited, the level of interface material 54 inside reservoir 600 decreases. The level decrease may be proportional to drop-volume and/or drop-weight of one or more nozzles 52 which is being activated. Level sensor 603 may sense and/or measure the level of interface material 54 inside reservoir 600, and/or the decrease in the level of interface material 54 inside reservoir 600. Thus, the amount of interface material 54 dispensed by each of nozzles 52 may be known. This data may be transferred, automatically and/or manually and/or periodically, for example, to controller 62. The data may be used by controller 62 for optimization, evaluation, adjustment and/or calibration of one or more nozzles 52 and/or printing heads 8.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors, or devices as are known in the art. Some embodiments of the invention may include buffers, registers, storage units and/or memory units, for temporary or long-term storage of data or in order to facilitate the operation of a specific embodiment.

While certain features of the invention have been illustrated and described herein, many modifications, substitutions, changes, and/or equivalents may occur to those skilled in the art. It is, therefore, to be understood that the appended claims are intended to cover all such modifications and/or changes.

1-42. (canceled)

43. A method of three-dimensional printing, the method comprising:
dispensing interface material from a three-dimensional printer;
evaluating one or more nozzles of a printing head of said printer in relation to a property of a portion of the material dispensed by said one or more nozzles; and
determining a property of the material dispensed.

44. The method of claim 43, comprising measuring one or more of a weight, a volume and a height of the material dispensed by said one or more nozzles.

45. New) The method of claim 43, wherein evaluating comprises forming a measuring block of said material and measuring a property of the measuring block, and wherein said property of said measuring block comprises one or more of the weight, the volume and the height of the measuring block.

46. The method of claim 43, wherein determining comprises determining any one or more of a weight, a volume and/or a height of a dispensed interface material.

47. The method of claim 43, wherein evaluating comprises forming a test pattern of said material.

48. The method of claim 47, wherein evaluating further comprises acquiring an image of said test pattern.

49. The method of claim 48, comprising modifying a property of said one or more nozzles in relation to a result of an analysis of the image of said test pattern.

50. The method of claim 43, further comprising modifying a property of one or more printing heads.

51. The method of claim 50, wherein modifying the property of said one or more print heads comprises modifying a voltage of the one or more nozzles.

52. The method of claim 50, wherein modifying the property of said one or more print heads comprises modifying a voltage of the printing head.

53. A method according to claim 43, comprising detecting one or more malfunctioning nozzles of said printing head.

54. The method of claim 53, comprising treating said one or more malfunctioning nozzles.

55. The method of claim 54 comprising providing notification of a need to replace said printing head, if a number of said one or more malfunctioning nozzles is greater than a predefined value.

56. The method according to claim 54, comprising:
analyzing a scatter pattern of said one or more malfunctioning nozzles;
and in relation to a result of the analysis, providing notification of a need to replace one or more printing heads.

57. A three-dimensional model printing apparatus comprising:
one or more printing heads, each printing head comprising one or more nozzles, to dispense said interface material;
a sensor to determine a property of a portion of the dispensed interface material; and
a controller to modify a property of said one or more nozzles or said one or more printing heads, in relation to the determined property of a portion of said dispensed interface material.

58. The apparatus of claim 57, wherein the property determined by said sensor may be any one or more of a weight, a volume, a drop volume and a height of the dispensed interface material.

59. The apparatus of claim 57, wherein the property modified is any one or more of a volume, a drop volume and a voltage.

60. The apparatus of claim 57, comprising a container to receive interface material dispensed from said one or more nozzles or said one or more printing heads, for determining any one or more of a weight, a volume, a drop volume and/or a height of said dispensed interface material.

61. The apparatus of claim 57, wherein the controller modifies a property of said one or more nozzles or said one or more printing heads in relation to any one or more of said weight, a volume, a drop volume and a height of said dispensed interface material.

62. The apparatus of claim 61, wherein said controller modifies a voltage or drive voltage of said any one or more nozzles or any one or more of said printing heads.

63. The apparatus of claim 57, wherein the portion of the dispensed interface material comprises a measuring block produced by said three-dimensional model printer.

64. The apparatus of claim 63 wherein the property of a portion of said dispensed interface material comprises one or more of a weight of said measuring block, a volume of said measuring block and a height of said measuring block.

65. The apparatus of claim 57, comprising an imager to acquire an image of a test pattern formed by the one or more nozzles.

66. The apparatus of claim 65, wherein said result comprises a number of malfunctioning nozzles.

67. The apparatus of claim 65, wherein said result comprises a scatter pattern of malfunctioning nozzles.
